(19) United States
(12) Patent Application Publication
(10) Pub. No.: US 2020/0126026 A1
(43) Pub. Date: Apr. 23, 2020

(54) GENERATING CUSTOMIZED ALERTS WITH COMPUTER VISION AND MACHINE LEARNING

(71) Applicant: Walmart Apollo, LLC, Bentonville, AR (US)

(72) Inventors: Mani Garlapati, Bangalore (IN); Rajesh Shreedhar Bhat, Karnataka (IN); Lakshmi Praneetha Kommuru, Bangalore (IN); Souradip Chakraborty, Karnataka (IN)

(21) Appl. No.: 16/209,959

(22) Filed: Dec. 4, 2018

(30) Foreign Application Priority Data
Oct. 20, 2018 (IN) 201841039670

(51) Int. Cl. G06Q 10/08; G06Q 30/06; G06K 9/32; G06K 9/62; G06N 3/04; G06N 3/08

(52) U.S. Cl. CPC G06Q 10/087; G06Q 30/0631; G06N 3/08; G06K 9/6227; G06N 3/0418; G06K 9/325

(57) ABSTRACT

Systems and methods are disclosed that enable more accurately generating customized alerts with computer vision (CV) and machine learning (ML), based on features extracted from collected imagery, when the features have contextual or situational significance. For example, a CV platform monitoring container content levels may generate an alert that may include placing a shopping cart entry or providing a purchase recommendation. Accompanying ML capability can leverage the CV historical data to improve container content and level determinations, and also adjust a consumption pattern threshold used as a trigger.

### BACKGROUND

Convolutional neural network (CNN) can detect objects, classify those objects, and extract features. Computer vision (CV) platforms may thus leverage CNNs to detect objects, classify those objects, and extract features. Object detection and classification, along with feature extraction may be relatively robust, given sufficient training of a CNN. However, extracted features may have contextual or situational significance, so that automated decision-making, such as generating actionable alerts based on extracted features, may often be sub-optimal. For example, automated alerts indicating that a supply of a product has run low may be generated too early or too late, resulting in either wasted resources ordering unnecessary replenishment, or else a shortage because replenishment was begun too late.

### SUMMARY

Systems and methods are disclosed that enable more accurately generating customized alerts with computer vision (CV) and machine learning (ML), based on features extracted from collected imagery, when the features have contextual or situational significance. For example, a CV platform monitoring container content levels may generate an alert that may include placing a shopping cart entry or providing a purchase recommendation. Accompanying ML capability can leverage the CV historical data to improve container content and level determinations, and also adjust a consumption pattern threshold used as a trigger.

A disclosed system for generating customized alerts with CV and ML comprises: a camera; a processor; and a computer-readable medium storing instructions that are operative when executed by the processor to: receive imagery from the first camera; detect a container within the imagery; determine contents within the container; determine an amount of the contents remaining within the container; compare the amount of the contents remaining within the container against a consumption pattern threshold; and based at least on determining that the amount of the contents remaining within the container is below the consumption pattern threshold, generate an alert.

### BRIEF DESCRIPTION OF THE DRAWINGS

The disclosed examples are described in detail below with reference to the accompanying drawing figures listed below:

FIG. 1 is a block diagram of a platform for generating customized alerts with computer vision (CV) and machine learning (ML);

FIG. 2A shows a flow chart illustrating exemplary operations involved in generating customized alerts with CV and ML that may be used with the platform of FIG. 1;

FIG. 2B shows a flow chart illustrating additional detail for operations included in FIG. 2A;

FIG. 3 shows another flow chart illustrating exemplary operations involved in generating customized alerts with CV and ML that may be used with the platform of FIG. 1;

FIG. 4 shows another flow chart illustrating exemplary operations involved in generating customized alerts with CV and ML that may be used with the platform of FIG. 1;

FIG. 5 shows another flow chart illustrating exemplary operations involved in generating customized alerts with CV and ML that may be used with the platform of FIG. 1; and

FIG. 6 is a block diagram of an example computing device for implementing aspects disclosed herein.

Corresponding reference characters indicate corresponding parts throughout the drawings.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity of presentation, this implied leading clause is not repeated ad nauseum.

Convolutional neural network (CNN) can detect objects, classify those objects, and extract features. Computer vision (CV) platforms may thus leverage CNNs to detect objects, classify those objects, and extract features. Object detection and classification, along with feature extraction may be relatively robust, given sufficient training of a CNN. However, extracted features may have contextual or situational significance, so that automated decision-making, such as generating actionable alerts based on extracted features, may often be sub-optimal. For example, if a CV platform is used to generate automatic ordering of supplies in a refrigerator or pantry, the household's consumption pattern threshold is an important consideration in whether a certain detected amount of some product is sufficient or low enough that replenishment will be needed soon. Without proper consumption pattern information, automated alerts indicating that a supply of a product has run low may be generated too early or too late, resulting in either wasted resources ordering unnecessary replenishment, or else a shortage because replenishment was begun too late.

Therefore, systems and methods are disclosed that enable more accurately generating customized alerts with CV and machine learning (ML), based on features extracted from collected imagery, when the features have contextual or situational significance. For example, a CV platform monitoring container content levels may generate an alert that may include placing a shopping cart entry or providing a purchase recommendation. Accompanying ML capability can leverage the CV historical data to improve container content and level determinations, and also adjust a consumption pattern threshold used as a trigger.

An example automatically adds items in to a shopping cart, based on its consumption from a household kitchen. This arrangement prevents early depletion of items in the kitchen as it keeps track of the consumption with reference to a pre-defined threshold. Cameras, or other optical sensors, positioned in various locations, such as within or nearby a refrigerator and/or a pantry, collect imagery of containers, such as jars, and use image recognition and deep learning techniques to identify the capacity and contents of the containers. When the contents of a container fall below a threshold, the replacement product is automatically added to a shopping cart. This begins the replenishment process prior to the complete depletion of a product.

Detecting containers on shelves may use a histogram of oriented gradient and linear support vector machines with non-maximum suppression. For labeled containers, deep optical character recognition (OCR) using a CNN and long-term short-term memory (LSTM) may be used to identify the contents, whereas for unlabeled containers, a pre-trained deep learning model with transfer learning may be used to identify contents. LSTM units are units of a recurrent neural network (RNN), and are well-suited to classifying, processing and making predictions based on time series data, since there can be lags of unknown duration between important events in a time series. If OCR and image recognition techniques cannot reliably determine the contents, a household's order history may be consulted to assist with resolving uncertainties, for example salt versus sugar. Household consumption rates may be tracked in order to determine a consumption pattern threshold to be used for triggering reordering. When the amount of the contents remaining within a container falls below the consumption pattern threshold, the respective items are automatically added to a shopping cart. Some examples may be used for inventory maintenance at a store or warehouse, including non-food items.

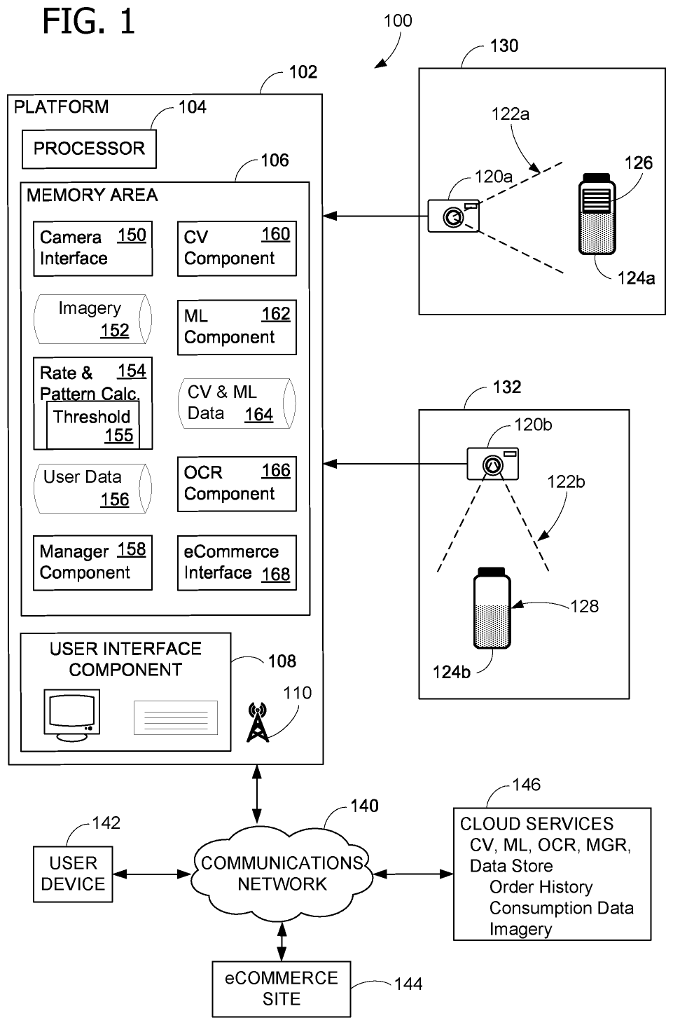

FIG. 1 is a block diagram of a platform 102 in an environment 100 for generating customized alerts with CV and ML. Platform 102 may alternatively take the form of a desktop computing device, a mobile computing device, or any other portable device. In some examples, a mobile computing device includes a mobile telephone, laptop, tablet, computing pad, netbook, gaming device, wearable device, and/or portable media player. Platform 102 may also represent less portable devices such as desktop personal computers, kiosks, tabletop devices, industrial control devices, wireless charging stations, electric automobile charging stations, and other physical objects embedded with computing resources and/or network connectivity capabilities. Additionally, platform 102 may represent a group of processing units or other computing devices.

In some embodiments, platform 102 includes at least one processor 104; a memory area 106, which is a computer-readable medium storing instructions that are executable by processor 104; and at least one user interface component 108, illustrated as having a display and an input component. Processor 104 includes any quantity of processing units and is programmed to execute computer-executable instructions for implementing aspects of the disclosure. The instructions may be performed by the processor 104 or by multiple processors 104 within platform 102 or performed by a processor external to platform 102. In some examples, processor 104 is programmed to execute instructions such as those that may be illustrated in the other figures.

Platform 102 also has one or more computer-storage media represented as memory area 106. Memory area 106 includes any quantity of computer-storage media associated with or accessible by platform 102. In particular, in memory area 102, a camera interface 150 comprises instructions that are operative to receive imagery from a first camera 120a in a first location 130. First location 130 is a storage location, such as perhaps including a kitchen refrigerator unit. Camera 120a has a first field of view 122a, which includes a container 124a holding a label 126. Camera interface 150 is further operative to receive imagery from a second camera 120b in a second location 132. Second location 132 is a storage location, such as perhaps a pantry unit, and is thus different than first location 130. It should be understood that first location 130 and second location 132 are merely exemplary, and that any suitable storage location may be used, including storage locations for non-food items. For example, warehouses, cabinets, shelving units, closets, and other storage units storing any type of merchandise or consumable goods may form a suitable storage location.

Camera 120b has a second field of view 122b, that is non-overlapping with first field of view 122a, and which includes a container 124b. Container 124b does not holding a label, and its contents are indicated by level 128. Based on the size (capacity) of container 124b, level 128 indicates an amount of the contents remaining within container 124b. Although two cameras and two containers are illustrated, it should be understood that a different number of cameras and containers may exist in some examples, and that other optical sensors may also be used.

Cameras 120a and 120b collect imagery, which is stored in imagery data store 152, for access by a CV component 160. CV component 160 uses CV algorithms, and possibly also neural net (NN) models in a ML component 162 to detect containers 124a and 124b within the imagery collected by cameras 120a and 120b and stored in imagery data store 152. Thus platform 102 is operative to detect a container within the imagery received from camera 120a or received from camera 120b. Data, such as models and training data for CV component 160 and ML component 162 are stored in a CV and ML data store 164. CV component 160 uses CV algorithms, and possibly also neural net (NN) models in a ML component 162 to determine contents within each of containers 124a and 124b, and determine an amount of the contents remaining within each of containers 124a and 124b.

One solution for determining contents within a container is to determine whether the container includes a label (e.g. a label is affixed to the container), and based at least on determining that the container does hold a label, performing an OCR process on the label. For example, container 124a includes label 126, so an OCR component 166 may be used to process imagery of label 126 on container 124a. Label 126 may include brand information, a description of the contents, or some other information that may be related to the contents, and assist a NN model in ML component 162 in determining the contents (for example, and without limitation, salt, sugar, flour or other food preparation ingredients) of container 124a.

With having determined the contents within a container and the amount of the contents remaining within a container, a manager component 158 can compare the amount of the contents remaining against a consumption pattern threshold 155 from a consumption rate and pattern calculation component 154. Based at least on determining that the amount of the contents remaining within the container is below consumption pattern threshold 155, manager component 158 generates an alert. In some examples, this alert may directly notify a user that the contents of a particular container are low, and in some examples the alert comprises a shopping cart entry, generated by an eCommerce interface 168. Other actions may also be accomplished based on having determined the amount of the contents remaining within a container. For example, based at least on the amount of the contents remaining within the container and a prior remaining amount as determined from prior imagery, consumption rate and pattern calculation component 154 may calculate a consumption rate. Based at least on the calculated consumption rate, consumption rate and pattern calculation component 154 may further adjust consumption pattern threshold 155. For example, if a particular product (e.g., flour) is being consumed at a faster rate than previously, then consumption pattern threshold 155 may be raised (increased) so that reordering will occur sooner. This helps ensure that more of that product arrives before the amount in the monitored container is fully depleted.

The specific amount to order, along with the particular brand and flavor (if any) may be determined from a container label size (e.g., label 126) by CV component 160 and ML component 162, or by an order history held in a user data store 156. Additionally, based at least on the calculated consumption rate, manager component 158 may also adjust a time interval for imagery collection. Initially, certain values may be set as defaults. For example, the scan rate may be a single time daily, which may be increased if rapid changes in container levels are detected. The consumption pattern thresholds for various products (e.g., multiple ones of consumption pattern threshold 155) may be set at some initial default value and may be adjusted over time as platform 102 develops a history of consumption rates. Product brands and sizes may be initially set to be top sellers or retailer recommendations, and adjusted based on the order history, or to match what is found within storage locations 130 and 132.

As illustrated, platform 102 additionally includes a communications component 110 provides communication between platform 102 and a communications network 140. Communications component 110 may include both wired and wireless communications capabilities. For example, eCommerce interface 168 uses communications component 110 to access an eCommerce site 144 in order to place an order for a product. A user device 142 (e.g., a smartphone or tablet) may access platform 102 via communications network 140, using communications component 110, so that a user who is away from home may consult with imagery data store 152 when at a retail store, for assistance in deciding whether to purchase more of a particular product. Further, platform 102 may access a cloud services provider 146, who may provide enhanced CV, ML, and OCR capabilities, a manager (MGR) for the scanning and threshold determinations, and store data, such as order histories, consumption data, and imagery. That is the components 150-168 of platform 102 may be additionally provided as a cloud service by cloud services provider 146.

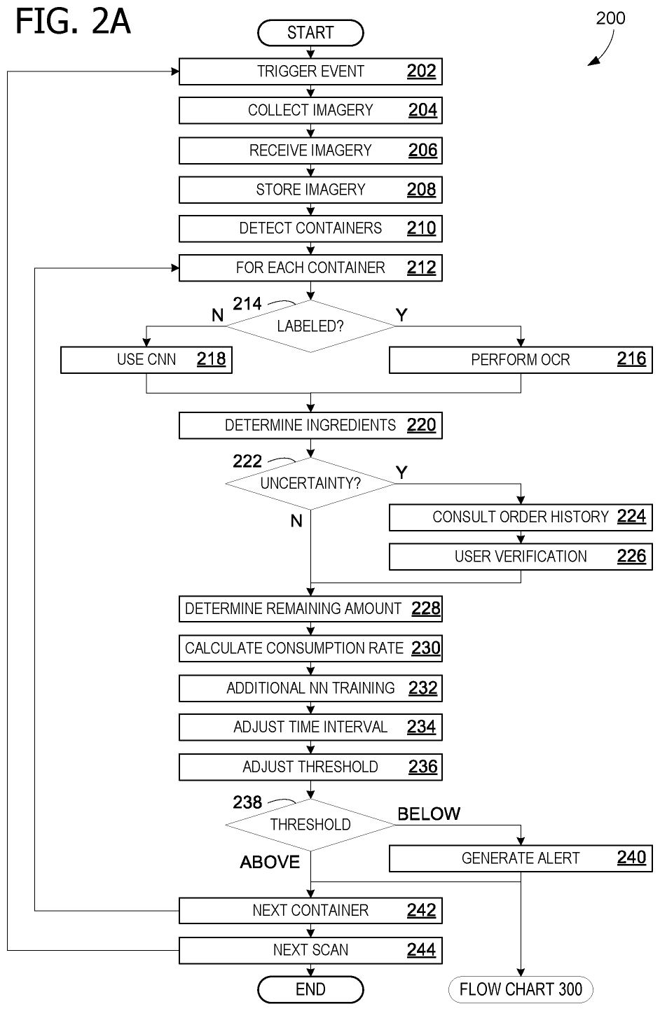

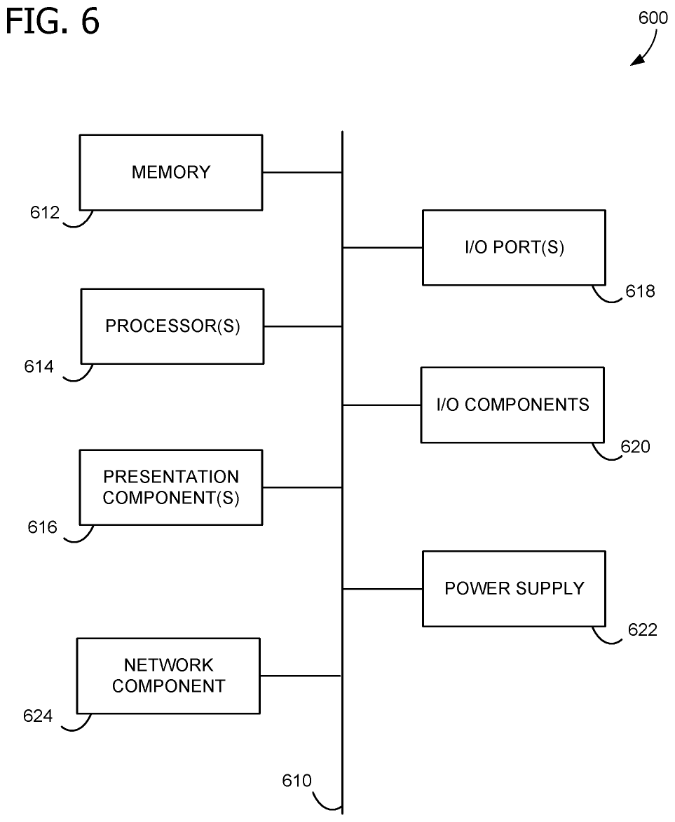

FIG. 2A shows a flow chart 200 illustrating exemplary operations involved in generating customized alerts with CV and ML that may be used with platform 102 of FIG. 1. The operations illustrated in flow chart 200 may also be performed by a compatible processing unit or computing node, such as the computing device 600 of FIG. 6. Operation 202 is a trigger event, such as a timer expiry starting a scan on a defined schedule, or a user initiating a scan. Other trigger events may also be used, such as a pantry or refrigerator door opening. Imagery is collected in operation 204 and operation 206 includes receiving imagery from a first camera and possibly receiving imagery from a second camera and other cameras. The imagery is stored in operation 208, and operation 210 includes detecting a container within the imagery. In some examples, detecting a container within the imagery comprises detecting a container within the imagery received from a first camera or received from a second camera.

More than one container may be detected in the imagery, during operation 210, so operation 212 manages cycling further operations through a set of detected containers. Decision operation 214 includes determining whether the (currently considered) container includes a label, such as a label is affixed to the container. If so, the operation 216 includes, based at least on determining that the container does hold a label, performing an OCR process on the label. Otherwise a CNN may be used in operation 218. The CNN may initially use features extracted from a VGG-16 model, but then be trained in an on-going fashion with continued use. Either of these routes leads to determining contents within the container in operation 220. If flow chart 200 had passed through operation 216, operation 220 includes, based at least on results of performing an OCR process on the label, determining contents within the container. If flow chart 200 had passed through operation 218, operation 220 includes, based at least on using a CNN with imagery of the container, determining contents within the container.

If there is a degree of uncertainty in operation 220, as determined in decision operation 222, perhaps by comparing a confidence value against a confidence threshold, operation 224 consults the user's order history to identify similar items that may be useful in resolving ambiguities or uncertainties. Also, or perhaps instead, operation 226 prompts a user for verification of the contents. The user's response may be used in further training of a CNN as a feedback loop, perhaps using ML component 162 (of FIG. 1).

Operation 228 then includes determining an amount of the contents remaining within the container. Otsu thresholding may be used. In CV and image processing, Otsu's method is used to automatically perform clustering-based image thresholding. Otsu's method exhibits relatively good performance when the data can be assumed to have bimodal distribution and also assumed to possess a deep and sharp valley between two histogram peaks. Operation 230 includes based at least on the amount of the contents remaining within the container and a prior remaining amount as determined from prior imagery, calculating a consumption rate. Operation 232 then provides for additional neural net training, such as for determining contents within containers, determining an amount of contents remaining within containers, and any NN-related consumption pattern models. Operation 234 includes, based at least on the calculated consumption rate, adjusting a time interval for imagery collection, if any adjustment is needed. This would alter the timing of the trigger events for some occurrences of operation 202. Operation 236 includes based at least on the calculated consumption rate, adjusting the consumption pattern threshold (e.g., consumption pattern threshold 155 of FIG. 1), if any adjustment is needed. In addition to consumption rate, delivery time may also be included in the calculation, with longer delivery times indicating a need to raise the consumption pattern threshold and order additional product earlier.

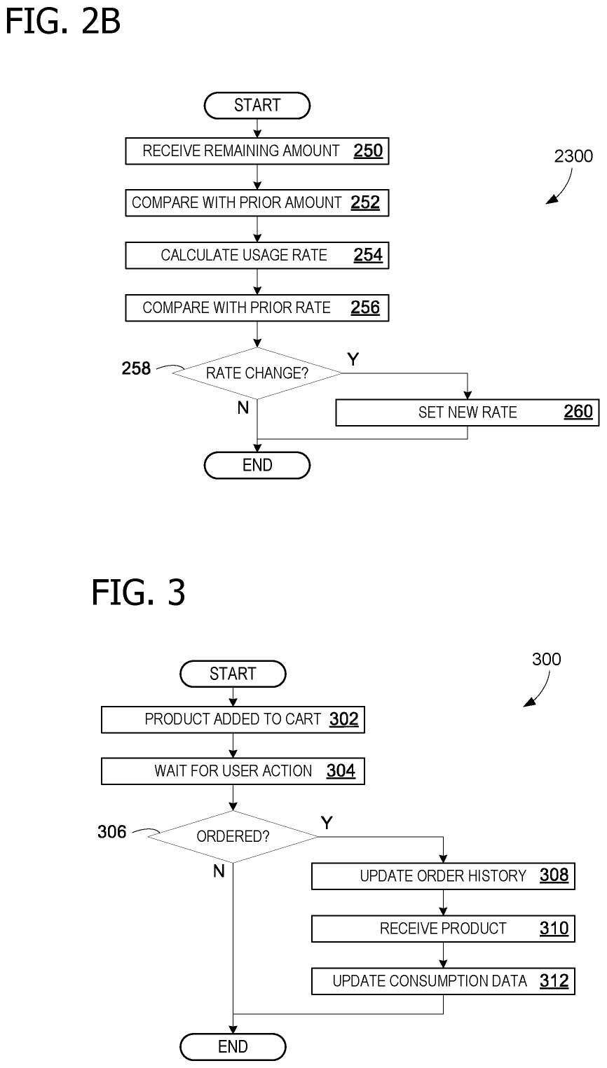

Decision operation 238 includes comparing the amount of the contents remaining within the container against a consumption pattern threshold. If the amount of the contents remaining within the container is below (lower than) the consumption pattern threshold, then operation 240 includes, based at least on determining that the amount of the contents remaining within the container is below the consumption pattern threshold, generating an alert. The alert may push a notification to a user. In some examples, the alert comprises a shopping cart entry, which is addressed in flow chart 300 (of FIG. 3), as indicated. If, however, the amount of the contents remaining within the container is above (higher than) the consumption pattern threshold, no alert is needed. Operation 242 returns to operation 212 to cycle for the next container. Operation 244 generates a trigger event, such as on a timer interval adjusted in operation 234, returning flow chart 200 to operation 202.

FIG. 2B shows a flow chart 2300 illustrating additional detail for operation 230 of FIG. 2A. FIG. 2B illustrates an exemplary process for, based at least on the amount of the contents remaining within the container and a prior remaining amount as determined from prior imagery, calculating a consumption rate. The amount of the contents remaining within the container, as determined in operation 228 (of FIG. 2A) is received in operation 250. Operation 252 compares this amount with a prior-determined amount, perhaps from when the operations of flow chart 200 had been performed at a prior time, or the prior amount may be set as full, if a new container has arrived. In some examples, the order history may be consulted to help identify a new full container. This comparison then provides a basis for operation 254 to calculate the amount used by subtracting the current amount, determined by the level to which the material fills the container and the container's volume, from the prior determined amount. The amount used is then divided by the time interval that has elapsed since the prior amount had been determined.

Operation 256 then compares this newly-calculated rate with a prior-calculated rate, perhaps a running windowed average, or perhaps the rate calculated when the prior amount was determined (and using the amount remaining at a time even prior to that). Decision operation 258 determines whether the usage rate has changed sufficiently to warrant setting a new rate. Some variation may be normal, so there may be a threshold for how much the rate should change before it is adjusted. If the rate has changed sufficiently, operation 260 sets a new rate. This may be as simple as substituting the new rate for the prior rate, or it may include using the new rate in a weighted, moving window average with the prior rate.

FIG. 3 shows a flow chart 300 illustrating exemplary operations involved in generating customized alerts with CV and ML that may be used with platform 102 of FIG. 1. The operations illustrated in flow chart 300 may be also performed by a compatible processing unit or computing node, such as the computing device 600 of FIG. 6. Operation 302 includes adding a product to a shopping cart, as part of an alert generated in operation 240 (of FIG. 2A). Operation 304 waits for user action, because the user may not wish to order the product, or may wish to order an additional quantity. That is, a recommendation to replenish a product, produced by the operations of flow chart 200 may be over-ridden by a user, rather than accepted and acted upon. This is indicated in decision operation 306. The shopping cart may contain multiple recommendations, so flow chart 300may be repeated for each.

If the user does order the recommended product, then the order history is updated in operation 308, for later consultation. The product is received in operation 310 and aced in a storage location, such as one of storage locations 130 and 132. Consumption data is updated in operation 312, to reflect that additional quantity of the product data has been purchased and is on hand. Consumption data for a product may include both purchase practices and usage rate. Delivery time may also be included, with longer delivery times indicating a need to raise the consumption pattern threshold and order additional product earlier.

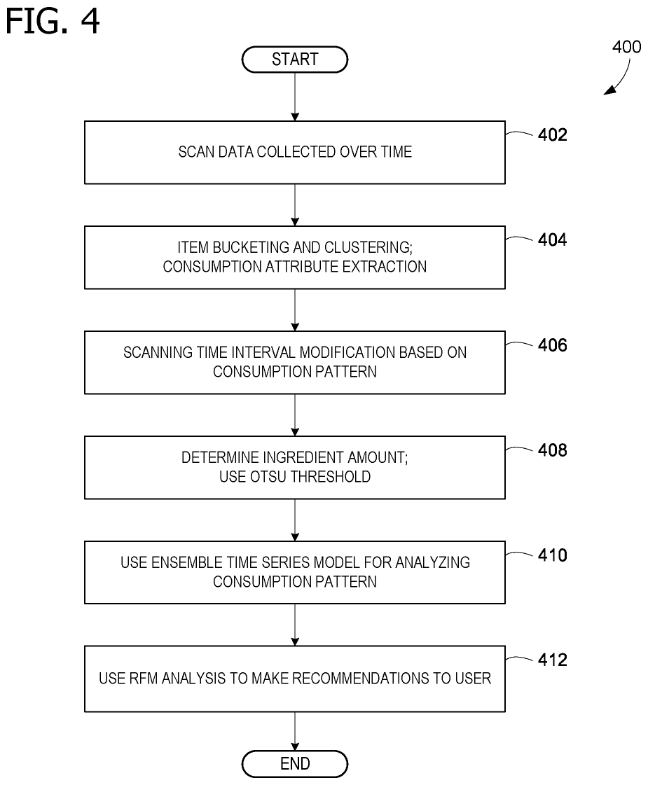

FIG. 4 shows another flow chart illustrating exemplary operations involved in generating customized alerts with CV and ML that may be used with the platform of FIG. 1. The operations illustrated in flow chart 400 may be performed by a compatible processing unit or computing node, such as the computing device 600 of FIG. 6. Operation 402 includes collecting scan data (imagery) over time. Container detection and classification may involve using a histogram of oriented gradients with linear support vector machines and non-maximum suppression. Image recognition and deep learning may be utilized to determine the capacity of a container and how empty or full it is.

Operation 404 includes item bucketing and clustering, and [symbol] consumption attribute extraction, and consumption pattern analysis. Bucketing is a data pre-processing technique used to reduce the effects of minor observation errors. The original data values which fall in a given small interval, a bin, are replaced by a value representative of that interval, often the central value. It may thus be considered to be a form of quantization. The clustering may include k-means clustering, which is a method of vector quantization and aims to partition n observations into k clusters in which each observation belongs to the cluster with the nearest mean, serving as a prototype of the cluster. Operation 406 includes scanning time interval modification based on consumption pattern. Initially, it may be set at some default interval, perhaps a day, but can grow or shrink based on the user's consumption patterns.

Operation 408 includes determining ingredient amount, perhaps using Otsu thresholding and horizontal histograms or a horizontal gradients method. Operation 410 includes using ensemble time series model for analyzing consumption patterns. Operation 412 includes using a recovery, frequency, monetary (RFM) analysis to make recommendations to user for ordering products.

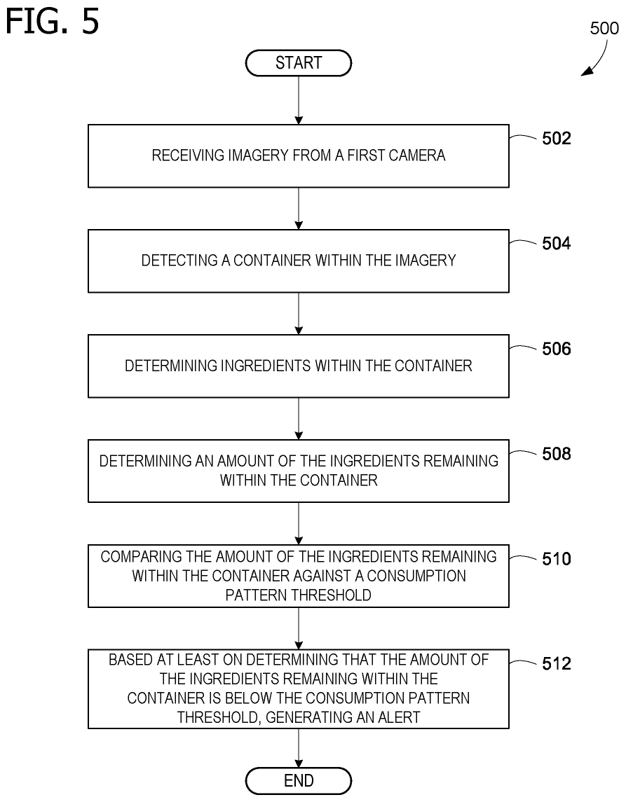

FIG. 5 shows a flow chart 500 illustrating exemplary operations involved in generating customized alerts with CV and ML that may be used with the platform of FIG. 1. The operations illustrated in flow chart 500 may also be performed by a compatible processing unit or computing node, such as the computing device 600 of FIG. 6. Operation 502 includes receiving imagery from a first camera, and operation 504 includes detecting a container within the imagery. Operation 506 includes determining contents within the container, and operation 508 includes determining an amount of the contents remaining within the container. Then, operation 510 includes comparing the amount of the contents remaining within the container against a consumption pattern threshold, and operation 512 includes, based at least on determining that the amount of the contents remaining within the container is below the consumption pattern threshold, generating an alert.

In some examples, the operations illustrated in the flowcharts 200-500 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements. While the aspects of the disclosure have been described in terms of various examples with their associated operations, a person skilled in the art would appreciate that a combination of operations from any number of different examples or some reordering is also within scope of the aspects of the disclosure.

### Exemplary Operating Environment

FIG. 6 is a block diagram of an example computing device 600 for implementing aspects disclosed herein. That is, computing device 600 may comprise a computer storage device having computer-executable instructions stored thereon for generating customized alerts with CV and ML, which, on execution by a computer, cause the computer to perform operations described herein. Computing device 600 is one example of a suitable computing environment and is not intended to suggest any limitation as to the scope of use or functionality of the invention. Neither should the computing device 600 be interpreted as having any dependency or requirement relating to any one or combination of components/modules illustrated.

The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments, where tasks are performed by remote-processing devices that are linked through a communications network.

Computing device 600 includes a bus 610 that directly or indirectly couples the following devices: memory 612, one or more processors 614, one or more presentation components 616, input/output (I/O) ports 618, I/O components 620, a power supply 622, and a network component 624. Computing device 600 should not be interpreted as having any dependency or requirement related to any single component or combination of components illustrated therein. While computing device 600 is depicted as a seemingly single device, multiple computing devices 600 may work together and share the depicted device resources. That is, one or more computer storage devices having computer-executable instructions stored thereon may perform operations disclosed herein. For example, memory 612 may be distributed across multiple devices, processor(s) 614 may provide housed on different devices, and so on.

Bus 610 represents what may be one or more busses (such as an address bus, data bus, or a combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and the diagram of FIG. 6 is merely illustrative of an exemplary computing device that can be used in connection with one or more embodiments. Distinction is not made between such categories as “workstation,” “server,” “laptop,” “hand-held device,” etc., as all are contemplated within the scope of FIG. 6 and the references herein to a “computing device.”

Memory 612 may include any of the computer-readable media discussed herein. Memory 612 may be used to store and access instructions configured to carry out the various operations disclosed herein. In some examples, memory 612 includes computer storage media in the form of volatile and/or nonvolatile memory, removable or non-removable memory, data disks in virtual environments, or a combination thereof

Processor(s) 614 may include any quantity of processing units that read data from various entities, such as memory 612 or I/O components 620. Specifically, processor(s) 614 are programmed to execute computer-executable instructions for implementing aspects of the disclosure. The instructions may be performed by the processor, by multiple processors within the computing device 600, or by a processor external to the client computing device 600. In some examples, the processor(s) 614 are programmed to execute instructions such as those illustrated in the flowcharts discussed below and depicted in the accompanying drawings. Moreover, in some examples, the processor(s) 614 represent an implementation of analog techniques to perform the operations described herein. For example, the operations may be performed by an analog client computing device 600 and/or a digital client computing device 600.

Presentation component(s) 616 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 600, across a wired connection, or in other ways.

Ports 618 allow computing device 600 to be logically coupled to other devices including I/O components 620, some of which may be built in. Examples I/O components 620 include, for example but without limitation, a microphone, keyboard, mouse, joystick, game pad, satellite dish, scanner, printer, wireless device, etc.

In some examples, the network component 624 includes a network interface card and/or computer-executable instructions (e.g., a driver) for operating the network interface card. Communication between the computing device 600 and other devices may occur using any protocol or mechanism over any wired or wireless connection. In some examples, the network component 624 is operable to communicate data over public, private, or hybrid (public and private) using a transfer protocol, between devices wirelessly using short range communication technologies (e.g., near-field communication (NFC), BLUETOOTH® branded communications, or the like), or a combination thereof

Although described in connection with an example computing device 600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

### Exemplary Operating Methods and Systems

An exemplary system for generating customized alerts with CV and ML comprises: a first camera in a first location; a processor; and a computer-readable medium storing instructions that are operative when executed by the processor to: receive imagery from the first camera; detect a container within the imagery; determine contents within the container; determine an amount of the contents remaining within the container; compare the amount of the contents remaining within the container against a consumption pattern threshold; and based at least on determining that the amount of the contents remaining within the container is below the consumption pattern threshold, generate an alert.

An exemplary method for generating customized alerts with CV and ML, implemented on at least one processor, comprises: receiving imagery from a first camera; detecting a container within the imagery; determining contents within the container; determining an amount of the contents remaining within the container; comparing the amount of the contents remaining within the container against a consumption pattern threshold; and based at least on determining that the amount of the contents remaining within the container is below the consumption pattern threshold, generating an alert.

One or more exemplary computer storage devices having a first computer-executable instructions stored thereon for generating customized alerts with CV and ML, which, on execution by a computer, cause the computer to perform operations which may comprise: receiving imagery from a first camera; detecting a container within the imagery; determining whether the container includes a label; and based at least on determining that the container does hold a label, performing an OCR process on the label; determining contents within the container; determining an amount of the contents remaining within the container; comparing the amount of the contents remaining within the container against a consumption pattern threshold; and based at least on determining that the amount of the contents remaining within the container is below the consumption pattern threshold, generating a shopping cart entry.

Alternatively, or in addition to the other examples described herein, examples include any combination of the following:
the alert comprises a shopping cart entry;
the first location includes a refrigerator unit;
a second camera in a second location;
receiving imagery from the second camera;
detecting a container within the imagery comprises detecting a container within the imagery received from the first camera or received from the second camera;
determining whether the container includes a label;
based at least on determining that the container does hold a label, performing an OCR process on the label;
determining contents within the container comprises based at least on results of performing an OCR process on the label, determining contents within the container;
based at least on the amount of the contents remaining within the container and a prior remaining amount as determined from prior imagery, calculating a consumption rate.;
based at least on the calculated consumption rate, adjusting the consumption pattern threshold; and
based at least on the calculated consumption rate, adjusting a time interval for imagery collection.

The order of execution or performance of the operations in examples of the disclosure illustrated and described herein may not be essential, and thus may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for generating customized alerts with computer vision (CV) and machine learning (ML), the system comprising:
a first camera in a first location;
a processor; and
a computer-readable medium storing instructions that are operative when executed by the processor to:
receive imagery from the first camera;
detect a container within the imagery;
determine contents within the container;
determine an amount of the contents remaining within the container;
compare the amount of the contents remaining within the container against a consumption pattern threshold; and
based at least on determining that the amount of the contents remaining within the container is below the consumption pattern threshold, generate an alert.

2. The system of claim 1 wherein the alert comprises a shopping cart entry.

3. The system of claim 1 wherein the first location includes a refrigerator unit.

4. The system of claim 1 further comprising:
a second camera in a second location;
wherein the instructions are further operative to:
receive imagery from the second camera; and
wherein detecting a container within the imagery comprises detecting a container within the imagery received from the first camera or received from the second camera.

5. The system of claim 1 wherein the instructions are further operative to:
determine whether the container includes a label; and
based at least on determining that the container does hold a label, performing an optical character recognition (OCR) process on the label.

6. The system of claim 5 wherein determining contents within the container comprises based at least on results of performing an OCR process on the label, determining contents within the container.

7. The system of claim 1 wherein the instructions are further operative to:
based at least on the amount of the contents remaining within the container and a prior remaining amount as determined from prior imagery, calculate a consumption rate.

8. The system of claim 7 wherein the instructions are further operative to:
based at least on the calculated consumption rate, adjust the consumption pattern threshold.

9. The system of claim 7 wherein the instructions are further operative to:
based at least on the calculated consumption rate, adjust a time interval for imagery collection.

10. A method for generating customized alerts with computer vision (CV) and machine learning (ML), implemented on at least one processor, the method comprising:
receiving imagery from a first camera;
detecting a container within the imagery;
determining contents within the container;
determining an amount of the contents remaining within the container;
comparing the amount of the contents remaining within the container against a consumption pattern threshold; and
based at least on determining that the amount of the contents remaining within the container is below the consumption pattern threshold, generating an alert.

11. The method of claim 10 wherein the alert comprises a shopping cart entry.

12. The method of claim 10 wherein the first location includes a pantry.

13. The method of claim 10 further comprising:
receiving imagery from a second camera, and
wherein detecting a container within the imagery comprises detecting a container within the imagery received from the first camera or received from the second camera.

14. The method of claim 10 further comprising:
determining whether the container includes a label; and
based at least on determining that the container does hold a label, performing an optical character recognition (OCR) process on the label.

15. The method of claim 14 wherein determining contents within the container comprises based at least on results of performing an OCR process on the label, determining contents within the container.

16. The method of claim 10 further comprising:
based at least on the amount of the contents remaining within the container and a prior remaining amount as determined from prior imagery, calculating a consumption rate.

17. The method of claim 16 further comprising:
based at least on the calculated consumption rate, adjusting the consumption pattern threshold.

18. The method of claim 16 further comprising:
based at least on the calculated consumption rate, adjusting a time interval for imagery collection.

19. One or more computer storage devices having computer-executable instructions stored thereon for generating customized alerts with computer vision (CV) and machine learning (ML), which, on execution by a computer, cause the computer to perform operations comprising:
receiving imagery from a first camera;
detecting a container within the imagery;
determining whether the container includes a label; and
based at least on determining that the container does hold a label, performing an optical character recognition (OCR) process on the label;
determining contents within the container;
determining an amount of the contents remaining within the container;
comparing the amount of the contents remaining within the container against a consumption pattern threshold; and
based at least on determining that the amount of the contents remaining within the container is below the consumption pattern threshold, generating a shopping cart entry.

20. The one or more computer storage devices of claim 19 wherein the operations further comprise:
based at least on the amount of the contents remaining within the container and a prior remaining amount as determined from prior imagery, calculating a consumption rate; and
based at least on the calculated consumption rate, adjusting the consumption pattern threshold.
